(19) United States
(12) Patent Application Publication
(10) Pub. No.: US 2006/0283419 A1
(43) Pub. Date: Dec. 21, 2006

(54) Continuous internal combustion engine

(76) Inventor: Ionel Mihailescu, Toronto (CA)

Correspondence Address: RIDOUT & MAYBEE LLP, ONE CITY CENTRE DRIVE, SUITE 308, MISSISSAUGA, ON, L5B 1M2, CA

(21) Appl. No.: 11/254,916

(22) Filed: Oct. 21, 2005

(30) Foreign Application Priority Data
Jun. 16, 2005 (CA) 2,509,485

(51) Int. Cl. F02B 53/00

(52) U.S. Cl. 123/204

(57) ABSTRACT

A continuous internal combustion engine, which has a combustion chamber, a fuel system that delivers a fuel-air mixture to the chamber and ignites the mixture, and a drum with plates that closes the combustion chamber, converting the energy in the expanding combustion gases into rotary motion before discarding the gases. The drum has an outer cylindrical surface centred about its rotational axis, and lengthwise slots are provided in the outer cylindrical surface. Plates extend through the slots, and are displaced radially between retracted and extended positions. The combustion chamber has lower and upper lips, which define circumferentially spaced-apart boundaries of the gate, along with the end plates on each side. The lower lip is in close proximity to the outermost cylinder of the drum, while the upper lip is spaced from the outermost cylinder of the drum, to define there between a discharge passage, gate, along with the end plates on each side. Also the plate is in close proximity to the edges of the slot in the drum. So friction exist just in sliders and bearings where exist pressure oil lubrication. A mechanical linkage, cam, solenoids, oil or air cylinders may be used to displace the plates radially, so that each plate are retracted to flush, with the outermost cylinder of the drum, when adjacent to the lower lip, and extends into close proximity to the upper lip, during passage through the discharge passage, gate, closing the passage, along with the end plates each side, for a period of time sufficient to allow a succeeding plate to extend into radially close proximity to the upper lip and close the passage.

### FIELD OF THE INVENTION

The invention relates to internal combustion engine and rotary combustion engines.

### BACKGROUND OF THE INVENTION

Internal combustion engines, diesel and gasoline are well known. Also, rotary combustion engines, are well known, and are to be found in U.S. Pat. No. 4,073,608 issued on Feb. 14, 1978 to Christy; U.S. Pat. No. 4,241,713 issued on Dec. 30, 1980 to Crutchfield; U.S. Pat. No. 4,830,593 issued on May 16, 1989 to Byram et al.; U.S. Pat. No. 4,998,867 issued on Mar. 12, 1991 to Sakamaki et al.; U.S. Pat. No. 5,427,068 issued on. Jun. 27, 1995 to Palmer; U.S. Pat. No. 5,489,199 issued on Feb. 6, 1996 to Palmer; U.S. Pat. No. 5,522,356 issued on Jun. 4, 1996 to Palmer; U.S. Pat. No. 6,526,937 issued on Mar. 4, 2003 to Bolonkin; and U.S. Pat. No. 6,659,066 issued on Dec. 9, 2003 to Lee. In general terms, these references disclose rotary engines and other rotary machines that use a rotor equipped with multiple vanes to provide pumping action or to convert energy contained in expanding combustion gases into rotary motion.

In each of these patents exist elements that make that these engines not to be able to work properly or even in short time of operating to fail, like:
vanes touching the rotary outermost cylinder, when operate, resulting overheating and damaging of the rotor.
vanes pushed into the rotary outermost cylinder, by the combustion gases pressure, when operate, resulting lose of power and overheating.
the combustion gases, from burning to the exhaust, when are producing power, are traveling to long way, some time being subjected to compression and expansion, all this means lose of power, specially at high rpm, where the speed of gases are high.
when is used Carnot engine cycle for the rotary engine, is almost not working, because when the combustion occur the pressure are against two vanes that are pushing in opposite direction, balancing each other.

The conventional internal combustion engine, diesel or gasoline, also has the following disadvantages:
a conventional internal combustion engine, 4 strokes or 2 strokes, is running with a very low efficiency, is loosing power in cooling system.
also because of leverage which is not constant, at the end of the stroke and at the beginning is very little loosing a lot of power.
again because is too complicated, with too many parts, it has a lot of power losing because of friction forces and being a very heavy mechanism is losing a lot of power at acceleration and need for braking powerful brake system and a body structure very strong which increase the weight of the car decreasing the overall efficiency.

With my invention I tried and I managed to overcome all of this disadvantages, and to obtain a most simple and efficient engine, which is also one of the most reliable engines.

The continuous internal combustion engine is working like some diesel engines where the injection of fuel is continuing for a short period of time to maintain the pressure, but unlike this, where the quantity of air is not replenished and the process is cyclic, continuous internal combustion engine is supplying air and fuel continuous and the engine cycle is continuous.

The continuous internal combustion engine is working on the principle of an engine with a continuous cylinder, which eliminate the reciprocating moving of the pistons that exist at of the conventional internal combustion engine. The air and fuel is continuous supply to the combustion chamber, is burning, the pressure of the burning gas is pushing the plate, on the shortest way, keeping the volume of the gases almost constant in the gate, and also the pressure of the gases are almost perpendicular on the plates, which is rotating the drum, which is turning the transmission. Here doesn't exist the conventional cooling system, leverage is optimum, and the system is much simpler, all this contribute to an optimum efficiency and cost.

### BRIEF SUMMARY OF THE INVENTION

In one aspect, the invention provides a rotary combustion engine which comprises a combustion chamber having a discharge passage, called gate, that accesses the interior of the chamber, means of delivering fuel and air to the interior of the combustion chamber and igniting the delivered fuel and air to produce combustion gases, and a drum that control escape of the combustion gases through the gate of the combustion chamber.

The drum has a rotational axis, an outer cylindrical surface centred about the rotational axis, and a number of slots formed in the outer cylindrical surface, also in the end plates, on each side. The slots are oriented parallel and radial to the rotational axis of the drum, and are equal spaced apart circumferentially about the outer cylindrical surface. The drum also has a number of plates each oriented parallel and radial to the rotational axis of the drum and each associated with a different slot. Plates displacement means are provided to displace each of the plates radially through the associated slot between a retracted orientation in which the plate is located entirely within the outer cylindrical surface and an extended orientation in which the vane extend beyond the outer cylindrical surface. The reason of this displacement of the plates is to let to the burning gases, from the combustion chamber, to escape to the exhaust just after passing the gate, the discharge passage, and after transferring almost all the energy to the drum. So no energy from the burning gasses is exhausted without to be used, except of friction of the air and in the rotating drum. That's way the gate, which is define be the circumferential distance between two consecutively plates, a little bit bigger, to ensure that the next plate came in the gate position just a little bit before the precedent plate get out of this gate, to ensure that no compressed combustion gasses are lost, and also the distance that the compressed combustion gasses have to travel through the restricted area, the gate, is as short as possible, to lose as little as possible energy through air friction, so the efficiency to be the best.

The plate displacing means comprise linkage means for positioning the radial displacement of the plates, such that each of the plates retracts, a little bit below the outer surface of the drum, in close proximity to this surface, in order that the plate not to touch the lower lip, when this come inside the combustion chamber, but also not to lose from the compressed combustion gasses, so not to lose energy. Also the displacing means realise the radial displacement of the plates in the gate area, so that here the plate are the maximum lifting, to ensure maximum pushing force, which pushing force is almost perpendicular on the radios, for eccentric shaft case, and perfect perpendicular in all other cases, (cam shaft, and for using solenoids or air or hydraulic cylinders, to position the plates), so that ensuring the maximum torque obtained. Also in the gate area the plates should be positioned in the close proximity of the upper lip, so that to lose as little as possible compressed gasses, and also the plates not to touch the upper lip in order not to have friction to overheat and damage the system, also the efficiency is maximum, specially at high rpm. For same reason the plates are in close proximity with side plates and the slots, also the outer surface of the drum is in close proximity with the lower lip and the side plates of the drum are in close proximity to the side plates of the combustion chamber. All of the above ensure that the lose of pressurised combustion gasses are minimum, and that in the area with high temperature, where is not possible to do a proper lubrication, don't exist friction. The only friction will be in cooler areas and where exist oil pressure lubrication, the sliding and rotational areas inside the drum. So that the engine will have the maximum efficiency, very high power for a very low weight and size, together with very high reliability.

Other aspects of the invention will be apparent from the description below of the preferred embodiment and will be more specifically identified in the appended claims. For purpose of certainty, the expression, “close proximity”, as used in this specification to describe the relationship between engine components, and similar expressions, should be understood as indicating a clearance or separation as small as machine tolerances permit, and no more than a few thousandths of an inch. Most significantly, the total clearances and consequently the net surface area through which combustion gasses can potentially escape non-productively should be significantly smaller than the effective cross-sectional area of the discharge passage, gate, in order to achieve reasonable efficiency. The word, “chamber”, should be understood as including both a space and the surrounding structure that defines that space.

### DESCRIPTION OF TE DRAWINGS

The invention will be better understood from drawings illustrating embodiments of invention, in which:

FIG. 1—is a vertical cross-section through a continuous internal combustion engine, the preferred embodiment, where the position of the plates are realised with eccentric shaft;

FIG. 2—is an elevation of an eccentric shaft for this engine;

FIG. 3—is an elevation showing basic support of the drum, internal construction of the drum and the system used for displacing the plates when using an eccentric shaft;

FIG. 4—is an elevation of the system used for rods in order to balance the most of the eccentric forces of the plates in their rotation motion and to reduce the relative motion of the rods, in order to reduce the friction forces, used with an eccentric shaft;

FIG. 5—is an elevation of the system used for rods in order to balance the most of the eccentric forces of the plates in their rotation motion and to reduce the relative motion of the rods, in order to reduce the friction forces, used with a solenoid system;

FIG. 6—is an elevation of the drum, to show the basic construction;

FIG. 7—is a perspective view of the exterior of the combustion chamber;

FIG. 8—is a view illustrating a fuel-air injection system;

FIG. 9—is a plan view of a plate comprised by the drum;

FIG. 10—shows an alternative way to realise the displacement of the plates using a cam shaft;

FIG. 11—shows an alternative way to real ise the displacement of the plates using electro-solenoids;

FIG. 12—shows an alternative way to realise the displacement of the plates using air or hydraulic cylinders;

FIG. 13—is a schematic representation of fuel-air supply system;

FIG. 14—is a schematic representation of pressure oil lubrication system;

FIG. 15—is a schematic representation of monitoring and control of the systems;

FIG. 16—is a view illustrating a possibility to realise an automatic continuous variable displacement, here using a cam system, for the case when using a cam-shaft to displace the plates;

FIG. 17—is a cross-section in the drum, for this case, to show basic construction;

FIG. 18—is an elevation showing the guiding system used in this case;

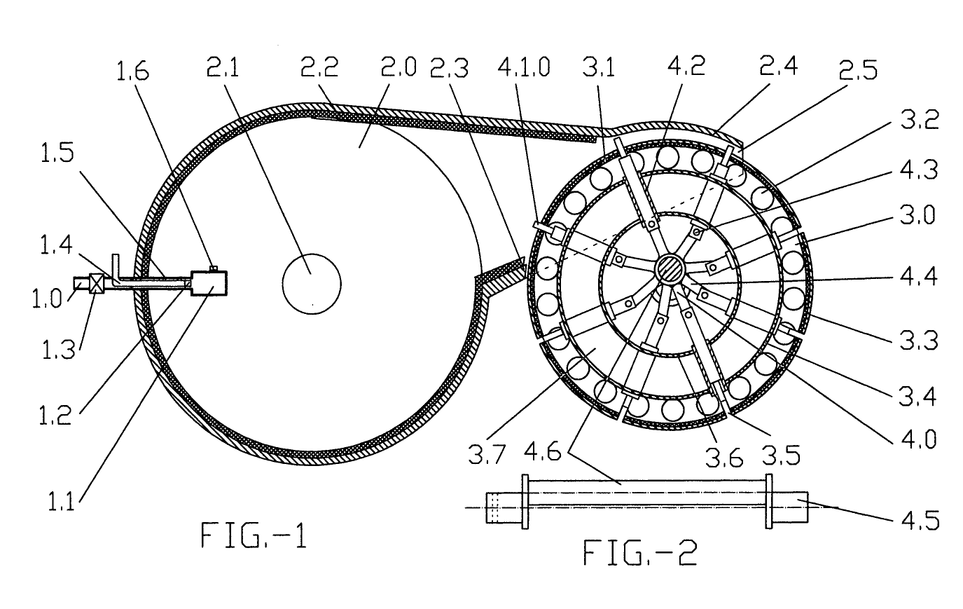

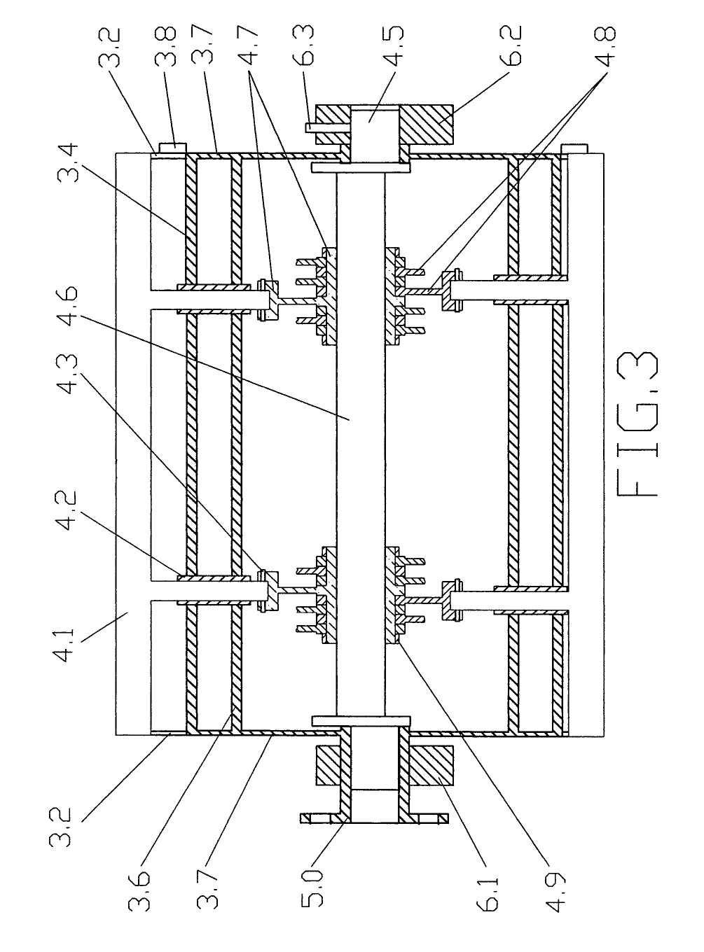

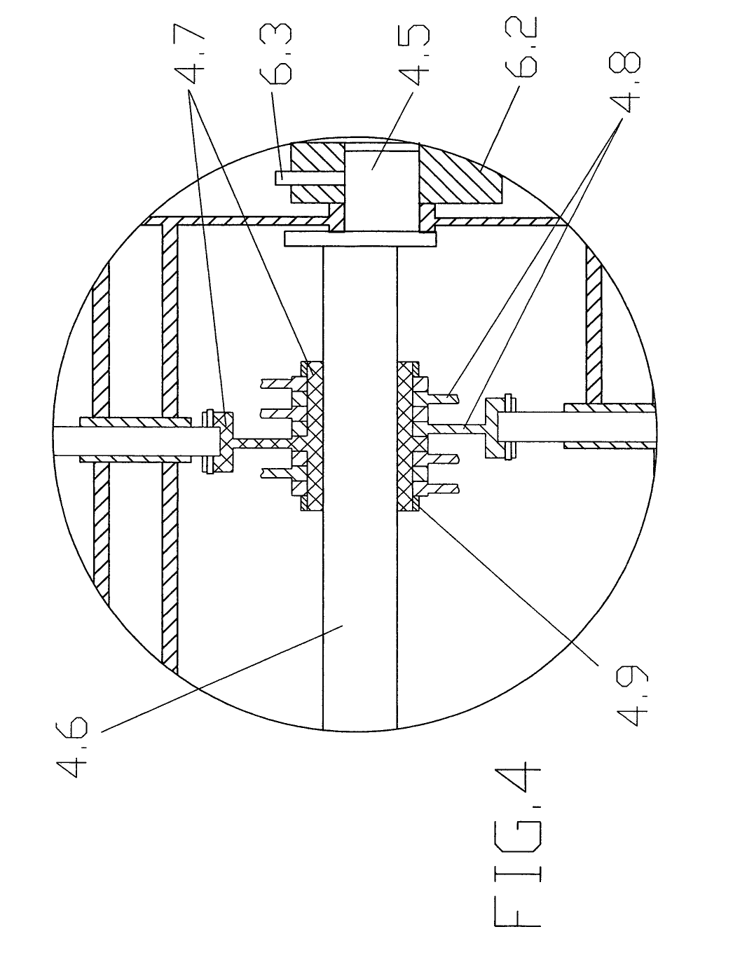

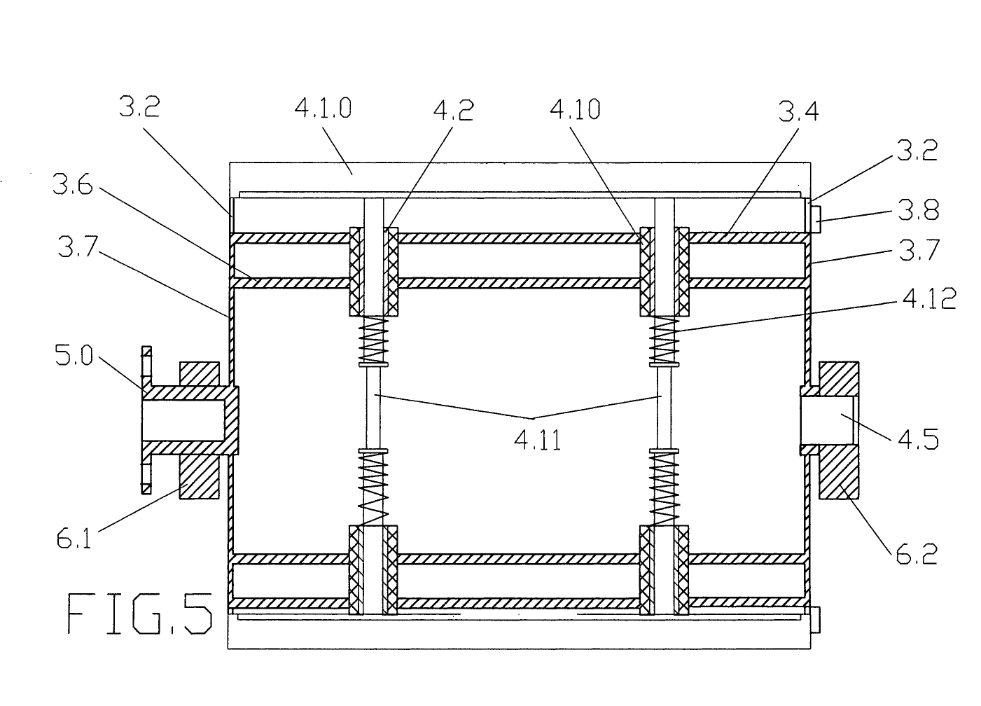

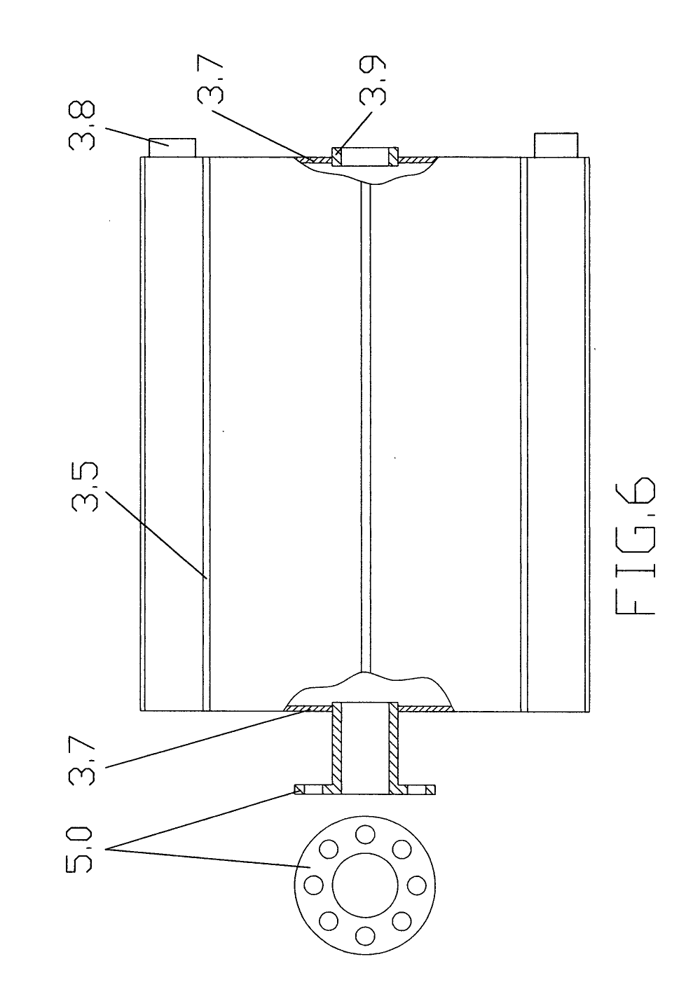

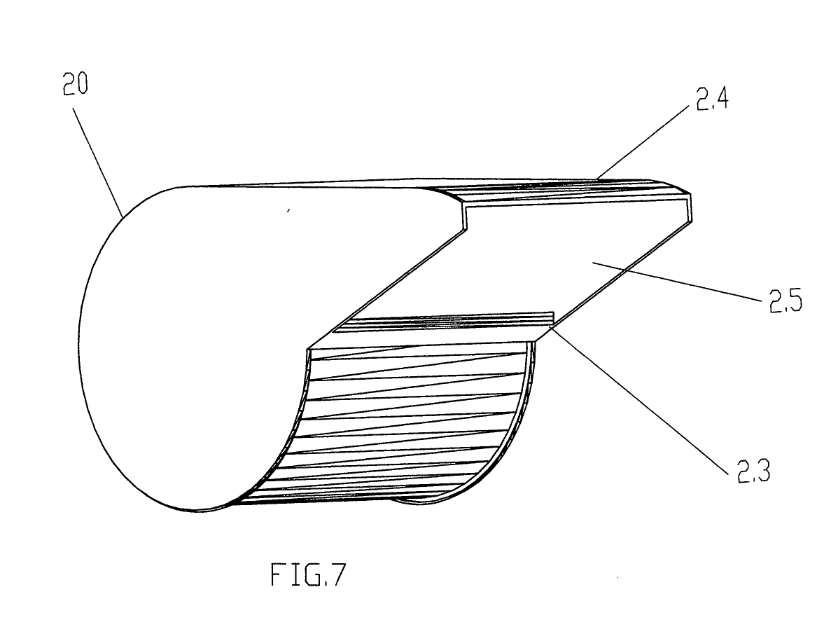

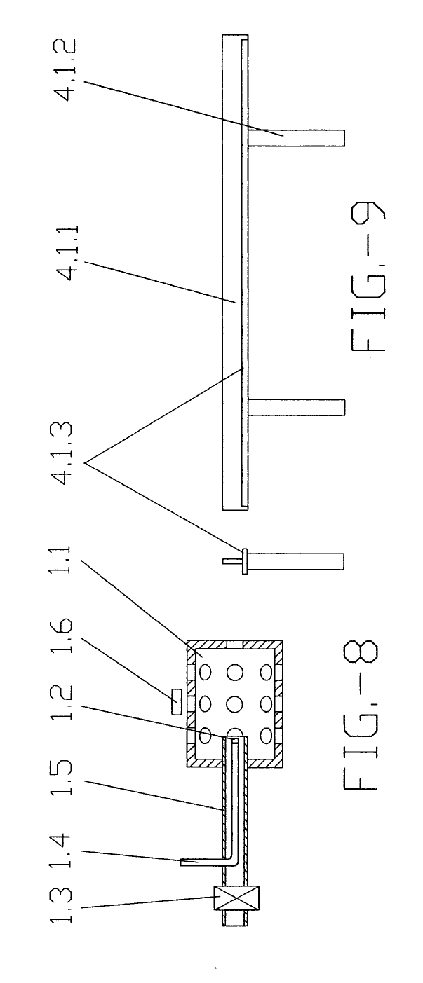

### PARTS LIST

1.0—fuel-air system
1.1—mixing chamber
1.2—fuel injector (electronically actuated)
1.3—air electro valve (electronically actuated)
1.4—fuel tube
1.5—air tube
1.6—sparker
2.0—combustion chamber
2.1—valve (chamber to atmosphere, electronically actuated)
2.2—heat insulation
2.3—lower lip
2.4—upper lip
2.5—end plates (two—one each side)
3.0—drum
3.1—heat insulation
3.2—side holes (a number of holes on each side—for the air to circulate, between outermost cylinder and intermediate cylinder, to do the hot air scavenging and cooling)
3.3—outermost cylinder
3.4—intermediate cylinder
3.5—slots (a number of slots, equal with number of plates)
3.6—innermost cylinder
3.7—end plates (two—one on each side)
3.8—fane blade (a number of fane blades—one for each hole on one side of the drum, which is the air flow producer between the outermost cylinder and intermediate cylinder, for cooling)
3.9—bushing
4.0—plates displacement system
4.1.0.—plates assembly (a number of plates assembly)
4.1.1—plates body (a number of plates body)
4.1.2—sliders (a number of sliders—two for each plate)
4.1.3—reinforcements (a number of reinforcements)
4.2—bushings (a number of bushings—two for each plate assembly)
4.3—pins (a number of pins—two for each plate assembly)
4.4—rods (a number of rods—two for each plate assembly)
4.5—central shaft (which give the rotational axis for drum)
4.5.1—cam center shaft
4.6—eccentric shaft (which give the rotational axis for the plates)
4.7—main rod (a number of main rods equal with one of the plate assembly sliders)
4.8—auxiliary rod (which ride on the main rod bushing)
4.9—stoppers
4.10—electro solenoid (a number of electro solenoids—one for each plate slider)
4.11—connecting rod (witch connect the diametric opposite plate sliders, to balance the centrifugal forces)
4.11.1—connecting system (used with cam center shaft)
4.12—springs (a number of springs—one for each plate slider)
4.13—rollers (a number of rollers—one for each plate slider)
4.14—pistons (a number of pistons—one for each plate slider, can be for air or oil)
4.15—cylinders (a number of cylinders—one for each plate slider, can be for air or oil)
5.0—coupling member
6.0—support system
6.1—left side bearing block
6.2—right side bearing block
6.3—holding pin (holds the shaft fix, not to rotate)
7.0—the system to realise an automatic continuous variable displacement
7.1—cylinder (hydraulic actuated)
7.2—gears
7.3—camshaft
7.4—rack (are in mesh with the gears)
7.5—bushing (where slide the rack)
7.6—spring (keep the rack in position)
7.7—bushings (are the rotational axes for cam shaft, 7.3)
7.8—guide sliders (which is guiding the camshaft up and down in the guide block, 7.9)
7.9—guide blocks
7.10—springs (which keep the camshaft, 7.3, in position)
7.11—guide blocks (two—on the central shafts, 4.5)
7.12—cams (two, on the camshaft, 7.19)
7.13—cams (two, on the sliding camshaft, 7.18)
7.14—rollers (a number of rollers—two for each plate assembly)
7.15—rollers (two—one each side of the sliding camshaft, 7.18)
7.16—springs (two—one each side of the sliding camshaft, 7.18, keep it in position)
7.17—guides (two—one each side of the sliding camshaft, 7.18)
7.18—sliding camshaft
7.19—camshaft
7.20—pins

### DESCRIPTION

Reference is made to FIG. 1 which illustrates a continuous internal combustion engine. The engine comprises a combustion chamber, 2.0, which has a discharge passage, gate, that accesses the interior of the chamber. A fuel-air system, 1.0, delivers a mixture of fuel and air to the interior of the combustion chamber and then ignites the mixture, producing rapidly expanding combustion gases. A drum, 3.0, and plates and positioning system, 4.0, controls escape of the combustion gases through the gate, converting the energy contained in the expanding gases into rotary motion of the drum. The coupling member, 5.0, transfers the power from the drum to the transmission, and the support system, 6.0, help holding and rotating the drum.

The fuel-air system comprises an outer tube, 1.5, through which air is delivered, and an inner tube, 1.4, through fuel is delivered. Air supply is controlled by an air electro valve, 1.3, electronically actuated, and fuel supply is controlled by a fuel injector, 1.2, electronically actuated. The air and fuel is supplied just when the acceleration pedal is depressed and is according with the position of the pedal. When the acceleration pedal is depressed less, so will be the air and fuel delivered, when the acceleration pedal is depressed more, more air and fuel will be delivered, and when the acceleration pedal is no depressed, no air and fuel is delivered. All this will be computer controlled. The air and fuel get mixed in the mixing chamber, 1.1, after that get ignited by the sparker, 1.6.

In the combustion chamber, 2.0, the burning of the fuel-air mixture take place, also act like a high pressure accumulator, where the pressure of the burning gases will be determined by the resistance forces, which is translated in torque resistance. So when the resistance forces at the wheals increase, the necessary torque increase, also in order to overcome this resistance torque, the pressure in the combustion chamber increase. So the sizes of the engine, plates, displacement, (the height of the plates in the gate area multiplied by the length of the plate, so the area on which the pressure act in the gate area), and combustion chamber will be so calculated that the maximum pressure in the combustion chamber to be always less than the pressure in the air supply tank, to be possible to supply air for burning. For example, if in the air tank would be 150 PSI, the maximum pressure in the combustion chamber should be 100 PSI. In order to reduce the heat loses, to increase the efficiency of the engine, on the inside or outside, of the combustion chamber can be used a heat insulation, 2.2. In the gate area the combustion chamber will have an upper lip, 2.4, and in the area where the combustion chamber came in close proximity with the drum will have a lower lip, 2.3. On the sides, to close the combustion chamber and the gate, the combustion chamber will have the end plates, 2.5. Also will exist a valve, chamber to atmosphere, electronically actuated, 2.1. This valve will get opened, automatically by the computer, when the acceleration pedal is not press and the driver want that the car to run by inertia, not to be braked by the engine brake. Closing the valve causes drag on the drum, because the drum when rotate by inertia and no air-fuel is supplied, create a vacuum, slowing operation of the engine When the acceleration pedal is press the computer automatically will close the valve, to be able to turn the engine. The only time when this valve is close, and the acceleration pedal is not press, will be when the driver want to use the engine brake, and will be actuated by pressing the brake pedal when first travel of the pedal will actuate the valve, 2.1, closing this gradually, for a smooth brake, and the last travel of the brake pedal will actuated gradually the conventional brakes also. In this way the necessary conventional brakes will be much smaller. All this will be done by the computer, according with the rotational speed of the drum, so the speed of the car, and according with the position of the brake pedal, so the grade of brake wanted, for a smooth braking. The combustion chamber comprises also a support structure, not shown.

The drum, 3.0, has a rotational axis and a support structure comprising a set of three concentric metal cylinders centered about the rotational axis: an outermost cylinder, 3.3, an innermost cylinder, 3.6, and an intermediate cylinder, 3.4, located between the outermost and innermost cylinders. The cylinders are connected, bolted or other way, to a pair of opposing, circular end plates, 3.7, that maintain the concentric relationship of the cylinders. A coupling member, 5.0, which may be a flange, like shown, or inside spline type, or any other way to do the coupling. This coupling member realise the coupling between the drum and transmission. The manner in which the drum is supported for rotation and for transfer of rotary power will be adapted to suit any practical application.

The outermost cylinder defines a generally circular cylindrical outer surface. A number of slots, 3.5, are machined in the outer cylindrical surface, and in the end plates, parallel and radial to the drum rotational axis, central shaft, 4.5, and equally spaced circumferentially about the outer cylindrical surface. The outermost cylinder has a heat insulation, 3.1, located on the inside side of this cylinder, in order to stop the heat lose from the combustion chamber, to increase the efficiency and to avoid overheating of the lubricating oil. Also in order to dissipate the heat escaping through the spaces between the plates and the sides of the slots, and in order that this gas not to go inside the innermost cylinder, 3.6, where exist the lubricating oil, between the outermost cylinder and intermediate cylinder, to avoid the overheating of the lubrication system, the end plates have in this area side holes, 3.2, on the both sides, to leave the air to circulate, and on one side each hole has a fane blade, 3.8, which forces ambient air to circulate between the outermost cylinder and intermediate cylinder, to avoid overheating. The bushing, 3.9, is used here to be possible that the drum, 3.0, to rotate on the central shaft, 4.5. All the bushings which are used by the drum to rotate on, will be pressure oil lubricated. When necessary, when is used gasoline, diesel, or other fuels which give noxes when burn, will exist a secondary exhaust for this separate from the conventional exhaust. When is using natural gas or hydrogen where is not noxes of burning this is not necessary. The pressure in the combustion chamber is lower than at a conventional engine, the burning temperature is lower, thus will not exist noxes NOx, so much less pollutions.

The plates positioning system, 4.0, is located inside the drum. A number of plates, 4.1.0, are associated with the slots in the drum. Displacement of the vanes is timed by the mechanical linkage. Each of the plates is retracted, below the outer surface of the drum, in close proximity to this, when is near the lower lip. The plate then extends radially to a fully extended orientation as exemplified in, FIG. 1. In the fully extended orientation, which is timed to occur when the vane reaches the entrance in the discharge passage, gate, the tip of the plate is in close proximity with the upper lip, and then obstructs the discharge passage against discharge of combustion gases. Because of the mechanical linkage involved, the plate remains only momentarily in its fully extended orientation and begins gradually to retract toward its retracted orientation. In this embodiment, using eccentric shaft, the upper lip of the drum extend and then contracts radially, outward and inward, in conformance to the radial, outward and inward, movement of the plates, so that the plates remain in close proximity to the upper lip, keeping the passage closed against any significant gas transfer, for a period of time sufficient to allow a succeeding plate to extend and come in the gate area, so to close the passage. This is true just for the case when is used eccentric shaft to realise the displacement of the plates. In all the other cases, using camshaft, electro solenoids, air or hydraulic cylinders, the trajectory in the gate area can be design to be perfect circular. The big advantage of this arrangement is that no compressed combustion gases are exhausted without the energy of this to be used, and also the passage length is as short as possible, in order to obtain the best efficiency for the engine. The plate comprises an elongate rectangular body, 4.1.1, and a set of two parallel sliders, 4.1.2, attached to the body. In an operative orientation, as in FIG. 1, the sliders extend radially inward from the plate body toward the rotational axis. The plates can have, if necessary, reinforcement, 4.1.3, in order to increase the rigidity. In all cases, using eccentric shaft, camshaft, electro solenoids or cylinders, to realise the displacement of the plates, the distance between the two sliders, 4.1.2, will be different for each set of two plates, diametric opposite, in order to avoid touching of the connecting rods, 4.11, 4.11.1, or because is used main rod, 4.7, and auxiliary rod, 4.8, the distance between the two sliders, 4.1.2, will be different for each plate, but always they will be equal distant from the each end of the plate. Each slider are sliding in one bushing, 4.2, which constrain the plate, through the sliders, to a radial movement, and is pressure oil lubricated, is mounted radially in the drum, relative to rotational axis, and secured one end to the innermost cylinder, and the opposite end to intermediate cylinder.

The plates are displaced in response to rotation of the drum. This are obtaining, here, when using an eccentric shaft, by using one rod, 4.4, for each slider, which connect the slider to the eccentric shaft, 4.6, and has the rotational axis the eccentric shaft, which stay in fix position by using the holding pin, 6.3, through the central shaft, 4.5, which is one piece with the eccentric shaft, 4.6. So when the drum is rotating with the rotational axis the central shaft, 4.5, the plates are rotating with it, and the displacement of the plates are constrained by the rods which have the rotational axis the eccentric shaft, 4.6, to realise the proper position of the plates relative to the position of the drum. The position of the eccentric shaft is so determined that in the gate area the lifting of the plates is maximum.

In order to realise the connection between the rods and plates sliders, are used the pins, 4.3, so the link can articulate here, when working.

Here in order to have less friction force, so less heat, especially at high speed, I wanted to balance the centrifugal forces and to reduce the relative motion of the rods when working. I managed to do this by using a main rod, 4.7, and auxiliary rods, 4.8, system, like in FIG. 3. In this case the auxiliary rod is riding on the main rod. There is one main rod for each slider of one plate, here two, and both main rods are connected to the sliders belonging to the same plate. The rest of the plates sliders are connected to the auxiliary rods which are riding on the main rods bushing. The stoppers, 4.9, can be used to keep the auxiliary rods in position. Both are oil pressure lubricated. In this way the main rod has a full rotation when working, but the centrifugal forces in the main rod bushing are almost balanced, because all centrifugal forces are acting on this bushing balancing each other. The auxiliary rods which take all the centrifugal forces will have in turn just move a fraction of the rotation, just the relative difference of position between the main and auxiliary rod, when working, which is much less than one full turn. In this way the friction, the heat, decreases substantially, and also the efficiency increase. This way to realise the displacement of the plates, using eccentric shaft can be used very well for high rpm, up to 30,000 rpm. All the other ways to realise the displacement of the plates, shown later, can be used for lower rpm, up to 10,000 rpm.

Other ways to realise the displacement of the plates are:

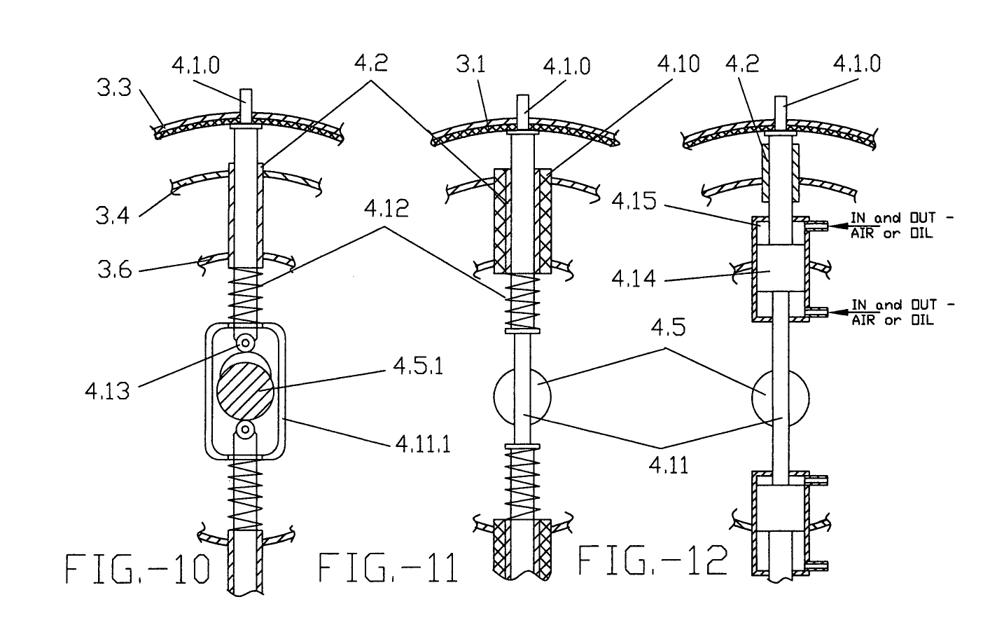

using a camshaft, like in FIG. 10, where the plates sliders will run on the camshaft, 4.5.1, by using rollers, 4.13, and springs, 4.12, are used to keep the plate in position. In this case the engine is cheaper and is easier to realise a certain moving of the plate, but at high rpm the plate can start floating, damaging the engine, and also the engine is losing power to overcome the inertia of the moving plate, decreasing the efficiency. So this way can be used at lower rpm.

using electro solenoids, 4.10, and springs, 4.12, like in FIG. 11. In this case the engine is more expensive, at high rpm the plate can start floating, and is losing energy for the necessary electricity to move the plate. The advantage would be that the moving of the plate is easy to control at lower rpm.

using pistons, 4.14, and cylinders, 4.15, which can use air or oil pressure, like in FIG. 12. In this case will have same advantages and disadvantages like using electro solenoids.

In all this three cases, the centrifugal forces can be balanced by using a connecting rod, 4.11, FIGS. 11 & 12, or the connecting system, 4.11.1, FIG. 10. This connecting rods connect two diametric opposite plates, reducing substantially the necessary forces for moving in position the plates by reducing the centrifugal forces of the two plates, and also can be used two electro solenoids or cylinders to move the system of two plates, so the necessary forces will be reduced and so the size of the devices.

The coupling member, 5.0, is used to transfer the torque from the drum to the transmission. This can be flange type, spline, or any other possibility to realise the torque transfer.

The drum is hold and rotates using a support system, 6.0, which comprise a left side bearing block, 6.1, and a right side bearing block, 6.2, FIG. 3. In order to realise the proper displacement of the plates, the eccentric shaft or camshaft, need to be hold in proper position, and this can be realised by using a holding pin, 6.3, spline, or any other way to do this.

This engine can be very easy design to have automatically continuous variable displacement. This can be realised by keeping fix the drum rotational axis, while changing the displacement of the plates and accordingly changing the position of the combustion chamber, in order to keep the close proximity between the plate and upper lip in the gate area. In order to have a direct relationship between movement of the plates and the movement of the combustion chamber, I used a cam system, two camshafts, 7.3, for the combustion chamber, which each extend on the other side of the combustion chamber, so exist four cams, two on each camshaft, and a camshaft, 7.19, for the sliding camshaft, 7.18, and all linked by a rack, 7.4. The sliding camshaft, 7.18, is connected to the central shaft, 4.5, at the both ends through the V shaped sliding guides, 7.17, and which is part of the sliding shaft. This guides, 7.17, slide in the V shaped guide blocks, 7.11, which are part of the central shaft, 4.5. Because of this guides the sliding camshaft, 7.18, is prevented from rotating, because also that the central shaft, 4.5, at one end is kept in fix position by the holding pin, 6.3, but can be moved up and down. This can be realised by rotating the camshaft, 7.19, which has two cams, 7.12, this cams push the sliding camshaft, 7.18, through the rollers, 7.15, and the pins, 7.20, which are mounted on the sliding camshaft, 7.18. Two springs, 7.16, on each side of the sliding camshaft, 7.18, keep this in position. The springs, 7.16, are mounted between the guides, 7.17, on the sliding camshaft, 7.18, and the guide blocks, 7.11, on the central shaft, 4.5. So according to the pressure in the combustion chamber, air or oil will actuate in the cylinder, 7.1, pushing the rack, 7.4, which on the other side has a spring, 7.6, and guide in the bushing, 7.5, to keep the rack, 7.4 in position. The rack make possible that the camshafts, 7.3 and 7.19, to move same rotational distance, through the gears, 7.2. The combustion chamber is push in position by the camshaft, 7.3, through the guide sliders, 7.8, which slides in the guide blocks, 7.9, and kept in position by the springs, 7.10. The camshafts are rotating in the bushings, 7.7. So when the rack, 7.4, is changing position according to the combustion chamber gasses pressure, which is according to resistance forces to the car wheels, this rack is rotating all the gears, 7.2, same angle, so the camshafts, 7.3 and 7.19, are rotating same angle, and because the cams on all this camshafts, 7.12, are the same, the movement of the combustion chamber and the sliding camshaft, 7.18, are same. And also because the plates are running on the cams, 7.13, which are part of the sliding camshaft, 7.18, through the rollers, 7.14, they will move the same. All this will be electronically controlled and actuated.

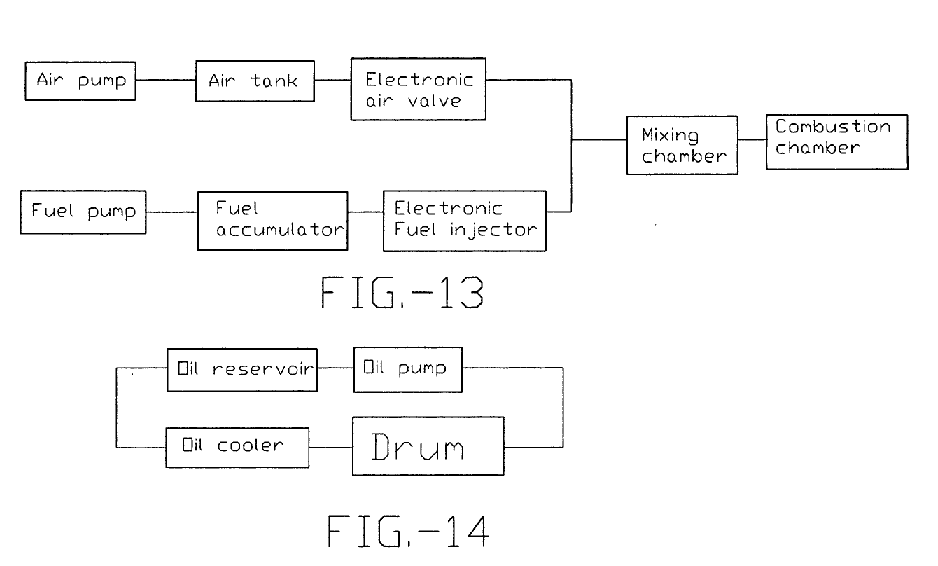

Reference is made to, FIG. 13, which diagrammatically illustrates how the air-fuel supply is done. An air pump, drive by the drum, is pumping the air into an air tank. From here air is supplied, through an air tube, using an electronically controlled air valve, into the mixing chamber. On the other hand, a fuel pump, drive by the drum, is pumping fuel in a fuel accumulator. From here fuel is supplied, through a fuel tube, using an electronically controlled fuel injector, into the mixing chamber, where is mixed with the air, and when the mixture came out of the mixing chamber into the combustion chamber, the sparker ignites the air-fuel mixture. This system can be design to obtain the wanted pressure in the mixing chamber and combustion chamber.

Reference is made to, FIG. 14, which diagrammatically illustrates how the drum is adapted to lubricate his rotational axis, mechanical-linkage and also remove the heat from the linkage. More specifically, the drum can comprise an oil inlet and an oil outlet, both accessing the interior of the innermost cylinder which contains the central shaft and mechanical linkage. A pump in communication with the oil inlet and oil outlet circulates lubricating oil to the lubrication points, sliding bushings and rotational bushings. An oil cooler in circuit, removes heat from the lubricating oil. Can be used an oil reservoir, or can be used the innermost cylinder of the drum as reservoir. Also the pump can be fitted inside the drum, and also the drum to play the roll of oil cooler.

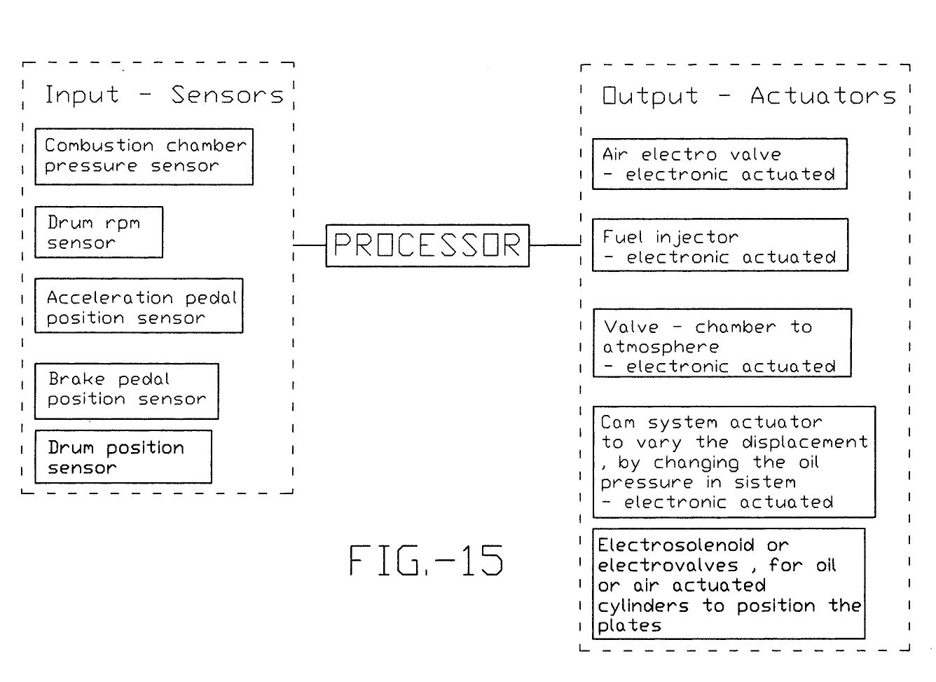

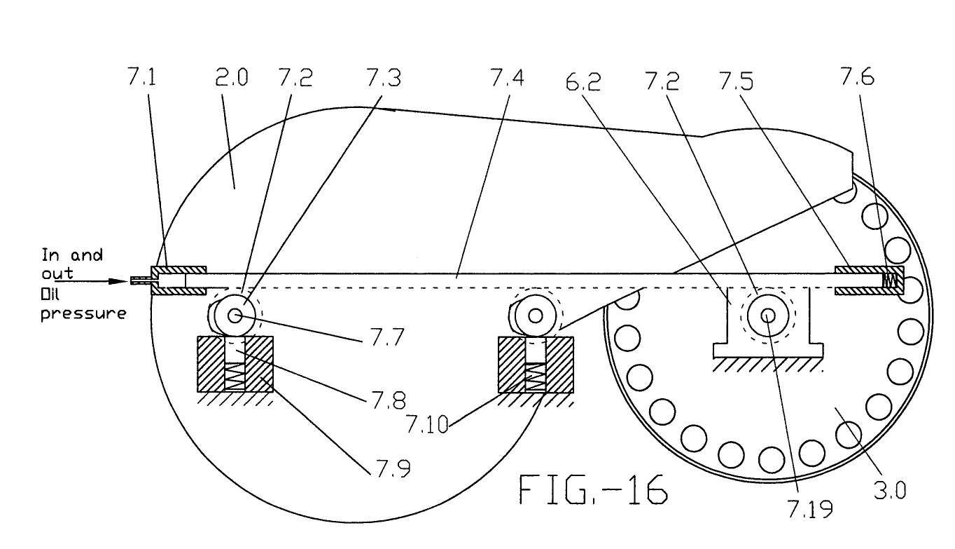

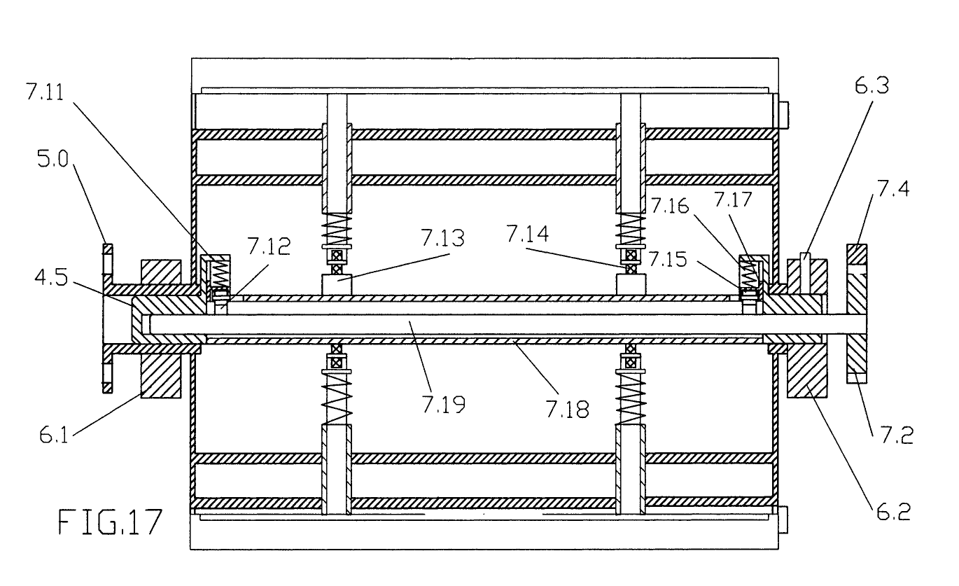

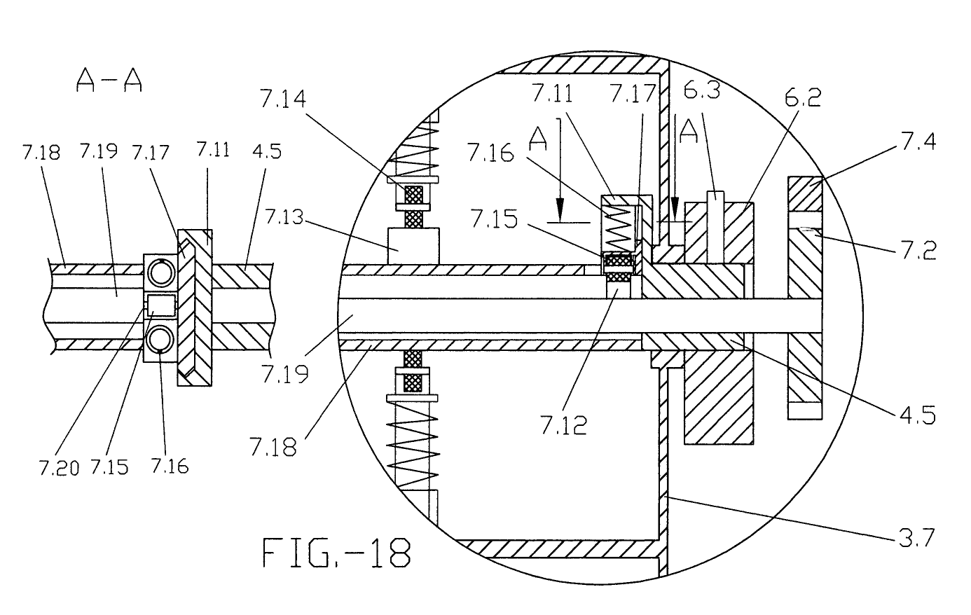

Reference is made to, FIG. 15, which diagrammatically illustrates how the electronic control can be done.

Input sensors can be used, like:
combustion chamber pressure sensor, to monitor the pressure in the combustion chamber;
drum rpm sensor, to monitor the drum rpm;
acceleration pedal position sensor, to know the level of acceleration desired;
brake pedal position sensor, to know the level of brake desired;
drum position sensor, used just when using electro solenoids, air or oil cylinders, when is necessary to know the position of the drum to actuate the displacement means;

This is just an example, there can be any other sensors.

A processor, computer, get the signals from the sensors, process this inputs, and according with this control different systems of the engine, using actuators, like:
air electro valve, to control the necessary air;
fuel injector, to control the necessary fuel;
valve, chamber to atmosphere, to control the position of this valve;
electro solenoids or electro valves, for oil or air actuated cylinders, used to displace the plates, so controlling the position of the plates;
cam system actuator to vary the displacement, by changing the oil or air pressure in the rack cylinder;

This is just an example, there can be any other actuators.

It will be appreciated that particular embodiments of the invention have been described and that modifications may be made therein without departing from the spirit of the invention or necessarily departing from the scope of appended claims.

The continuous internal combustion engine has many advantages, beside the conventional internal combustion engine, these are:
first and the most important is that the thermal efficiency of continuous internal combustion engine will be almost double than of a conventional internal combustion engine. The continuous internal combustion engine is losing power just through leakings in the gaps, which will be little because the gaps are little, and through exhaust. Roughly the loss in gaps will be less then 5% and in the exhaust about 20%, here doesn't exist conventional cooling system for combustion chamber, which is thermal insulated, just an oil cooling for the drum, roughly another 5% loss of power, so in this case the thermal efficiency would be about 70% which is almost double then for the conventional internal combustion engine, which is about 35%, and is much lower at low speed and high speed. Would be the most efficient internal combustion engine in the world. Because jet engine is less efficient than the internal combustion engine, even if is faster, and rocket engine is the fastest but the least efficient. The turbine engine will also be less efficient, because this is using the inertia of the burning gas, and continuous internal combustion engine is using the pressure of the burning gas, so is using all the energy of this gas. The only existent engine more efficient would be the fuel cell which transform the hydrogen directly in electricity, but seams having a big disadvantage, the fact that for high power this cells to produce enough electricity would need very big fuel cells, so they use batteries to store electricity when the necessary power is not high and to use this when the necessary power is higher. This increase the cost and weight of the car, making it not efficient for high power.
because this type of engine has good efficiency from low rpm, about 200 rpm, to very high rpm, up to 30,000 rpm, in this case is no more necessary to have a transmission with many speeds, cold be enough just a speed reduction, and inversion of rotational direction. Would be enough just to use a torque converter, with centrifugal lock up, coupled to the engine, and this coupled to a simple planetarium speed reduction, with a back up possibility. So the start will be smooth without to lose power after get some speed. In this way all the system engine transmission would be very easy so very little inertia, thus very efficient acceleration and deceleration, making it very efficient for running in the city. Because this system is easy the vehicle frame will be easier so all the vehicle will weight less, thus increasing the overall efficiency of the system vehicle.
continuous internal combustion engine has a much higher thermal efficiency and also much more constant on all range of rotational speed, beside the conventional engine which has a low efficiency at low or high rpm.
because is a very simple system, make it cheap for building, cheap maintenance and repair.
this engine will have much less vibration, and just when accelerate or decelerate, at constant rpm the engine will have almost no vibration. So the vehicle will run much smoother, so much better driver comfort.
this engine at deceleration, when air and fuel supply is stopped, acts like a very efficient auxiliary engine brake. Because of this and that the vehicle is easier, the necessary brake system will be much lighter, so cheape. To be possible not to brake the vehicle when wanted, the combustion chamber can have a gate, a valve to leave the air to pass. This valve will be actuated electronic.
this engine, because the exhaust pressure pulsation is very low, will run with much less noise and vibration than the conventional engine.
with this engine is possible that, when the acceleration pedal is not depressed, to stop complete the fuel and air supply, thus decreasing the fuel consumption.
the pressure in combustion chamber, for this engine, is lower, so temperature of burning is lower, thus the exhaust noxes will be lower, NOx will not exist any more, so will be less noxes. Also when using gasoline fuel is no more necessary to use EGR valve to reduce burning temperature and NOx noxes, which also increase the engine thermal efficiency. So will have enhanced thermal efficiency.
because continuous internal combustion engine has the torque much more constant then a conventional engine, the torque leverage is almost constant, is no more necessary to have a flywheel, or maybe a very small one for very big engines.
the continuous internal combustion engine can be build from very small size, but still high torque, so high power, to very big size, with very high torque and power. So the continuous internal combustion engine can be used for almost all kind of vehicle, motorcycles, cars, flying cars, planes, boats, atomic submarines, of course using the steam instead of combustion gas, and maybe even for building much more efficient space shuttles.\

Same invention can be used very well as an air pump. With the only differences that the drum will drive by an engine, will not exist fuel-air system, the combustion chamber will serve as discharge chamber and will be much smaller, and where been the fuel-air supply will be now a discharge valve connected to the air tank. So when the engine rotates the drum, in opposite direction than the engine, the air will be push into the discharge chamber through the gate, pressure rise and open the discharge valve to fill the air tank. This pump will be very simple construction, very good efficiency, and also very reliable. Same like the air pump, with the only difference that the drum will have different rotational direction and the air will be supplied from an air tank, can be build a very efficient air motor.

I claim:

1. A continuous internal combustion engine comprising:
a combustion chamber having a discharge passage, gate, that accesses the interior of the chamber;
means for delivering, mixed fuel and air, to the interior of the combustion chamber, and igniting the delivered, fuel and air, to produce combustion gases;
a drum that controls escape of combustion gases through the gate of the combustion chamber;
the said drum comprising a rotational axis, an outer cylindrical surface centered about the rotational axis, a multiplicity of slots in the outer cylindrical surface and end plates, the said slots oriented substantially parallel and radial to the said rotational axis, spaced apart circumferentially about the said outer cylindrical surface, a multiplicity of plates, each of the said plates associated with a different one of the said slots and oriented substantially parallel and radial to the said rotational axis, and plate displacing means for displacing each of the said plates radially to the said slot associated with the said plate between a retracted orientation, in which the plate is located entirely within the said outer cylindrical surface and an extended orientation in which the said plate extends beyond the said outer cylindrical surface;
the combustion chamber comprising lower and upper lips oriented generally parallel to the rotational axis and defining circumferentially space-apart boundaries of the gate, the said lower lip in close proximity to the outer cylindrical surface, the said upper lip spaced from the outer cylindrical surface to define there between a discharge passage, said gate, for discharge of pressurised combustion gases from the said combustion chamber, the said combustion chamber further comprising structure in close proximity to axially apposing ends of the said drum and configured to obstruct escape of combustion gases from the said gate adjacent to the axially opposing ends of the said drum, also the said plates sides are in close proximity to the said slots edges in order to lose as little as possible gases together with obtaining no friction in this area;
the plate displacing means comprising timing means for timing radial displacement of the said plates such that each of the said plates retracts, below the outer surface to almost flush, whenever the said plate is adjacent to the said lower lip, and each of the said plates extends into close proximity to the said upper lip during movement of the plate through the discharge passage, gate, thereby closing the discharge passage against escape of combustion gases, for just a period of time sufficient to allow a circumferentially succeeding said plate to extend into radially close proximity to the said upper lip, exist just a very small overlap when two plates are in the gate at same time, in order not to lose compressed burning gases but also the gate length to as short as possible to increase the engine efficiency specially at high rpm.

2. the engine in claim 1 in which the air and fuel delivering means comprise:
an air tank, supplied by an air pump, an air tube which connect the said air tank to the mixing chamber, and an air electro valve, to monitor the air supplied;
a fuel accumulator, supplied by a fuel pump, a fuel tube to connect the said fuel accumulator to the said mixing chamber, and a fuel injector, to monitor the fuel supplied; and,
electronic control means comprising a computer and acceleration pedal sensor, to control the air fuel mixture delivered to the said combustion chamber, so that when acceleration pedal is depressed the air fuel mixture is delivered according with the position of the pedal, with the acceleration pedal not depressed, no air or fuel is delivered to the said combustion chamber.

3. The engine of claim 1 in which:
the plate displacing means comprising a multiplicity of solenoids, springs, for returning the said plate in initial position, each of the said solenoids and springs having a displacement axis that is radially oriented relative to the rotational axis, a different set of said solenoids connected to and associated with each of the plates; and,
the timing means comprise means for sensing the angular orientation of the said drum about its said rotational axis, and means for electrically actuating the set of said solenoids associated with each of the said plates in response to the sensed angular orientation, thereby to displace the associated said plate between its retracted and extended orientations.

4. The engine of claim 1 in which:
the plate displacing means comprising a multiplicity of air cylinders, each of the said air cylinders having a displacement axis that is radially oriented relative to the rotational axis, a different set of said air cylinders connected to and associated with each of the plates; and,
the timing means comprise means for sensing the angular orientation of the said drum about its said rotational axis, and means for electrically actuating the set of air electro valve associated with each of the said air cylinders, associated with each of the said plates in response to the sensed angular orientation, thereby to displace the associated said plate between its retracted and extended orientations.

5. The engine of claim 1 in which:
the plate displacing means comprising a multiplicity of hydraulic cylinders, each of the said hydraulic cylinders having a displacement axis that is radially oriented relative to the rotational axis, a different set of said hydraulic cylinders connected to and associated with each of the plates; and,
the timing means comprise means for sensing the angular orientation of the said drum about its said rotational axis, and means for electrically actuating the set of hydraulic electro valve associated with each of the said hydraulic cylinders, associated with each of the said plates in response to the sensed angular orientation, thereby to displace the associated said plate between its retracted and extended orientations.

6. The engine of claim 1 in which:
the plate displacement means comprise a cam shaft with same axis as central shaft, so rotational axis, and springs, to keep the said plate in position;
in which the cams define the displacement of the said plates which are riding on the said cams using rollers, and the said springs keep the said plates in permanent contact with the said cams.

7. The engine of claim 1 in which the plate displacing means comprise:
a central shaft, being in fixed position, and being the said drum rotational axis;
an eccentric shaft, offset from the rotational axis, which determine the position of the said plates, and, mechanical linkage means coupling each of the said plates to the eccentric shaft for radial displacement in response to rotation of the said drum.

8. The engine of claim 1 in which, for each of the plates, the plate displacing means comprise:
a set of sliders attached to the said plate;
guide means constraining each of the said plates to displace radially, the guide means comprising a set of radially extending bushings, each receiving a different one of the said sliders, each of the said bushings, having one end secured to the intermediate cylinder and the opposite end secured to the innermost cylinder.

9. The engine of claim 7 in which the plates displacing means further comprise:
a central shaft aligned with the rotational axis of the drum, the said drum rotate around the said central shaft, which is in fixed position, the said central shaft comprising an eccentric shaft offset from the rotational axis; and,
a set of rods associated with each of the said plates, each of the said rods having one end pivoted to a different one of the said sliders, attached to the said plate and an opposite end pivoted to the eccentric section of the central shaft, said eccentric shaft.

10. The engine of claim 9 in which the plates displacing means further comprise:
a set of main rods both connected to a set of sliders belonging to same plate and is riding on the eccentric shaft; and,
a multiplicity of auxiliary rods, one for each of remaining said sliders belonging to the other said plates, which are riding on the outside of the said main rods bushings, in order to reduce the centrifugal forces, and reduce the relative movement of the rods, so to reduce the friction forces and heat generating, increasing the efficiency.

11. The engine of claim 1 in which the drum comprises:
a set of concentric cylinders centered about the rotational axis, the concentric cylinders including an outermost cylinder which defines the outer cylindrical surface of the drum and an innermost cylinder whose interior contains the central shaft and the mechanical linkage means;
an inlet port and an outlet port each accessing the interior of the said innermost cylinder; and,
means communicating with the inlet and outlet ports for circulating oil through the interior of the said innermost cylinder, to pressure oil lubricate the said sliders of the said plates and the rotational bushings of the said drum.

12. The engine of claim 11 in which the drum further comprise a radiator in circuit with the means circulating the lubricating oil such that the said radiator dissipates heat from the lubricating oil.

13. The engine of claim 11 in which the drum further comprise:
the concentric cylinders include an intermediate cylinder located between the said outermost and, said innermost, cylinders and cooperating with the said outermost cylinder to define an annular space there between;
an air inlet and an air outlet, a multiplicity of circular holes in each of the end plates of the said drum, each accessing the annular space; and,
means that help air inlet for circulating air through the annular space thereby to draw heat away from the drum annular space, comprising a number of fane blades, one for each inlet side holes, welded on the inlet side, end plate, above the inlet holes.

14. The engine of claim 11 in which the drum further comprise a heat insulation layer on the inside of the outermost cylinder, in order to stop the heat to transfer, together with the air ventilation between the said outermost cylinder and said intermediate cylinder, to the innermost cylinder, not to overheat the lubricating oil, to increase the reliability of the engine.

15. The engine of claim 1 in which:
the combustion chamber comprise inside a valve comprising an open state, in which the valve places the interior of the combustion chamber in communication with the atmosphere, and a closed state, in which the said valve isolates the interior of the combustion chamber from the atmosphere;
a brake sensor operable to indicate a requirement for slower rotation of the drum;
an acceleration sensor operable to indicate a requirement for faster rotation of the said drum; and,
control means, responsive to the brake and acceleration sensors, for placing the said valve in its closed state in response to operation of the acceleration sensor, pedal, for placing the said valve gradually in its closed state in response to operation of the brake sensor, pedal, and placing the said valve in its open state when not actuating both acceleration and brake pedals.

16. The engine of claim 15 in which the combustion chamber further comprise, a layer of heat insulation which can be inside or outside of the said outermost cylinder, in order not to let the heat from the said combustion chamber, given by the burning air and fuel mixture, to escape to atmosphere and to be almost all useful, increasing the engine efficiency.

17. The engine in claim 3, 4, and 5 in which the plates displacing means further comprise:
a multiplicity of connecting rods which connect each two diametral opposite plates sliders in order to balance the most of the centrifugal forces, for less friction forces, less necessary energy to move the said plates, less heat, and increase the efficiency.

18. The engine in claim 6 in which the plates displacing means further comprise:
a multiplicity of connecting systems which connect each two diametral opposite plates sliders in order to balance the most of the centrifugal forces, for less friction forces, less heat, and increase the efficiency.

19. The engine of claim 6 which, in order to realise an automatically continuous variable displacement, further comprise:
a rack in mesh with three gears connected to three camshafts, two of them giving the position of the combustion chamber and have correspondence on both sides of the said combustion chamber, each having two cams, one on each side, and the third giving the position of the sliding camshaft on which are riding the said plates so changing the position of said plates displacement, and having two cams, one on each side of the said camshaft which are pushing through the said rollers the said sliding camshaft;
the rack are sliding on one end in a cylinder, air or oil actuated, and on the other end is sliding in a bushing, having a spring to keep the said rack in position;
the combustion chamber support means, comprising four guide sliders, solider with the said combustion chamber, two on each side, which are sliding in four guide blocks, solider with the chassis frame, one for each said guide sliders, and having each one spring to keep the said combustion chamber in position;
the sliding camshaft sliding means, comprising two V shaped guides, one on each side of the said sliding camshaft, which are sliding in the V shaped guide blocks, one on each side on the central shafts, two rollers, one on each side and four springs, two on each side help keeping the said sliding camshaft in position;
position control means, comprising a combustion chamber pressure sensor, oil or air pressure control, an electro solenoid, electronically actuated, so when the pressure in said combustion chamber increase the position control system actuate the electro solenoid so that the rack to move so to lift both said sliding camshaft and said combustion chamber in order to increase the displacement of the engine, accordingly when the pressure in the said combustion chamber decrease the system work to reduce the displacement moving the said sliding camshaft and said combustion chamber down; because of the said rack which connect all the positioning camshafts, through the gears, the moving of the said sliding camshaft is correlate with the moving of the said combustion chamber, so they are moving exactly the same, keeping the reciprocal position of the said plates and upper lip constant.

20. The engine in claim 1 in which:
this engine can be used very easy as an air pump, with only differences that the drum will drive by an engine, will not exist fuel-air system, the combustion chamber will serve as discharge chamber and will be much smaller, and where been the fuel-air supply will be now a discharge valve connected to the air tank;
this engine can also be used as an air motor, same like the air pump, with the only difference that the drum will have different rotational direction and the air will be supplied from an air tank
